(19) United States
(12) Patent Application Publication
(10) Pub. No.: US 2003/0184630 A1
(43) Pub. Date: Oct. 2, 2003

(54) Drying station

(76) Inventor: Steven B. Elgee, Portland, OR (US)

Correspondence Address: HEWLETT-PACKARD COMPANY, Intellectual Property Administration, P.O. Box 272400, Fort Collins, CO, 80527-2400, US

(21) Appl. No.: 10/112,433

(22) Filed: Mar. 29, 2002

(51) Int. Cl. B41J 2/01

(52) U.S. Cl. 347/102

(57) ABSTRACT

A drying station produces a boundary layer relative to wet media when present therein. An air source moves air relative to the boundary layer. A sound source applies sound energy to the boundary layer.

### BACKGROUND OF THE INVENTION

The present invention relates generally to printing methods and apparatus, and can relate to liquid colorant drying as applied in the context of, for example, inkjet printing operations.

Inkjet printing produces print imaging by propelling ink droplets onto media. A variety of inkjet printing apparatus have evolved, but generally share in the common characteristic of rendering an image by depositing liquid on a media substrate. The liquid evaporates or volatilizes leaving behind print imaging. As such, inkjet printing methods and operations sometime include drying of media, e.g., drying liquid portions of ink following application thereof to media as print imaging. Thus, the “wet” nature of ink as applied to produce print imaging by inkjet printers has given rise to heating or drying devices to promote ink drying.

Inkjet drying techniques include passing media with wet print imaging against or near heated rollers and platens. Wet print imaging will smudge, however, if the drying apparatus contacts the print imaging. The application of heat to and consequent drying of wet media when in a curved condition, e.g., as wrapped against a roller, can result in undesirable cockling and/or buckling or curvature of output. As a result, such media can suffer in quality. In some cases, additional processing is used to “flatten” the media. Preferably, media ultimately dries in a generally flattened condition and thereby more readily assumes a desired end condition.

A microwave applicator positioned downstream from a printzone can apply heat by microwave radiation to media passing therethrough.

Generally, application of heat to wet ink volatilizes the ink and thereby dries print imaging rendered thereby. Volatizing ink produces ink vapor and can contaminate a printing operation. Volatilized ink compounds can be carried away from a printing operation to prevent excessive buildup of such compounds as in volatilized form or as settling back in a liquid form or a dry form. Some ink drying methods and apparatus can carry away volatized ink compounds to avoid contamination of the printing operation. A separate system for carrying away and suitably venting or managing volatized ink compounds can be used for this purpose.

Volatilized ink compounds also affect further drying when accumulated at the media surface. More particularly, volatized ink compounds accumulate to form a cloud or “boundary layer” at the media surface. This body of volatilized ink can slow productive further volatilization of ink and thereby slow further productive drying of print imaging. Accordingly, ink drying methods and apparatus sometimes “scrub” this boundary layer to remove a body of volatilized ink compounds and thereby promote further more productive drying of print imaging. Applying an airflow to a boundary layer disturbs volatilized ink compounds thereof and thereby scrubs-away the boundary layer to promote more productive drying of print imaging.

### SUMMARY OF THE INVENTION

A drying station produces a boundary layer relative to wet media when present therein. An air source moves air relative to the boundary layer. A sound source applies sound energy to the boundary layer.

The subject matter of the present invention is particularly pointed out and distinctly claimed in the concluding portion of this specification. However, both the organization and method of operation of an embodiment of the invention, together with further advantages and objects thereof, may be understood by reference to the following description taken with the accompanying drawings.

### BRIEF DESCRIPTION OF THE DRAWINGS

FIG. 1 illustrates in perspective an inkjet printer mechanism including a sound assist drying station according to an embodiment of the present invention.

FIG. 2 illustrates a form of the sound assist drying station of FIG. 1.

FIG. 3 illustrates application of airflow useful for a sound assist drying station.

FIGS. 4-8 illustrate various alternative drying station embodiments including variation in energy source, variation in number and placement of sound sources, and variation in airflow.

### DETAILED DESCRIPTION OF THE PREFERRED EMBODIMENT

The illustrated embodiment shows ink drying assistance in the context of inkjet printing by application of sound energy to a volatilized ink boundary layer. A boundary layer forms at the surface of media during an ink drying process. The boundary layer includes vaporized liquid colorant components, e.g., ink components, produced by application of energy to wet ink. Vaporized components in the boundary layer tend to frustrate and in some cases can substantially halt further vaporization of colorant components in or on the media. Under the illustrated embodiment, however, sound energy, e.g., sound waves, disturb the boundary layer sufficiently to aid in scrubbing free the boundary layer and thereby promoting more productive vaporization of ink components on or within the media.

Introducing an airflow through a region of boundary layer disturbed by sound waves further promotes disruption and removal, e.g., scrubbing, of the boundary layer. A more productive ink drying process results. A variety of devices and methods may be used to apply energy and vaporize ink components and to ultimately dry or substantially dry print imaging.

An airflow alone has been used to scrub a boundary layer. Use of an airflow alone, however, requires significant air velocity and/or air volume to produce productive scrubbing action of a boundary layer. The illustrated embodiment makes productive use of an airflow of lower air volume and air velocity to accomplish boundary layer scrubbing due to concurrent disturbance in the boundary layer produced by application of sound energy thereto. Overall, this removes vaporized ink in the boundary layer with less airflow.

Air movement and turbulence can be undesirable in the vicinity of an inkjet printzone. Because inkjet printing relies on predictable ink droplet trajectories, air movement and turbulence can introduce undesirable deflection of ink droplet trajectories. Thus, increased airflow reduces drying time, but can affect print image quality. Illustrated embodiments of the present invention support improved drying by use of a reduced magnitude airflow relative to that often used in the context of inkjet drying.

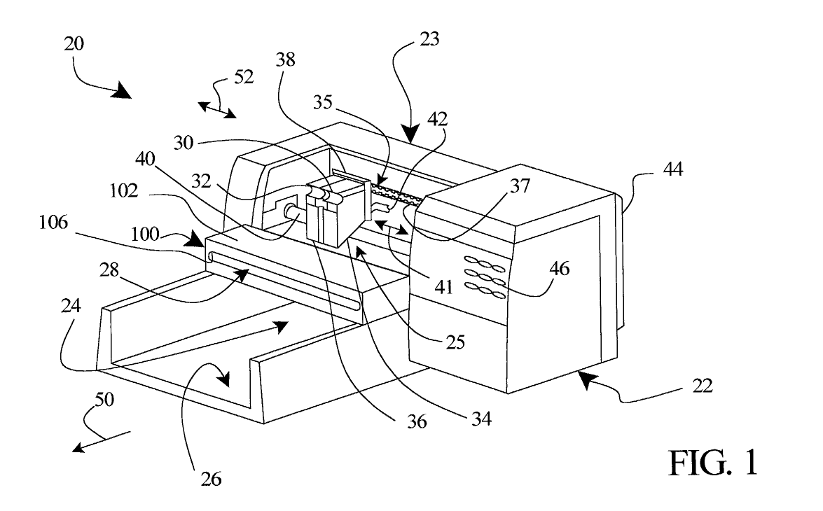

FIG. 1 illustrates an inkjet printing mechanism, specifically an inkjet printer 20. An embodiment of present invention will be illustrated in the context of or as applied to an inkjet printing mechanism, e.g. in the context of or as applied to an inkjet printer 20 of FIG. 1. It will be understood, however, that printer components and particular component architectures vary widely from model to model and that the present invention in its broader aspects applies across a variety of specific inkjet printing mechanism implementations beyond particular embodiments illustrated herein.

Printer 20 includes a chassis 22 and enclosure 23. An internal media handling system 24 supplies sheets of media (not shown in FIG. 1) to the printer 20. Media may be of a variety of generally sheet-form materials, but will be referenced herein as paper or media for the purpose of describing an illustrative or particular embodiment of the present invention. Handling system 24 moves media through a printzone 25 located along a feed path within enclosure 23. The feed path begins at a feed tray 26 and ends at an output area 28. A variety of media transport mechanisms and techniques can be used. Generally, such mechanisms and techniques can include a device for collecting individual media from input tray 26 and a set of various driven and pinch rollers propelling media along a media feed path through printer 20 and to output area 28.

As described more fully hereafter, the illustrated embodiment of the present invention concerns drying media following application of print imaging in printzone 25. As such, printer 20 operation will be described herein primarily with respect to media handling at or downstream from printzone 25, e.g., generally after application of print imaging to media therein.

In printzone 25, media moves longitudinally along the feed direction 50 and receives print imaging formed by application of liquid colorants, e.g., by projecting ink droplets originating from a supply in a replaceable inkjet cartridge, such as a black inkjet cartridge 30 and/or a color inkjet cartridge 32. Generally, cartridges 30, 32, or “pens” as referenced by those familiar with the art, hold a selected ink formulation suitable for application to a selected media or particular print job. A variety of ink formulations has evolved across a variety of uses and variety of available media. It will be understood, however, that the particular embodiment of the present invention illustrated herein is not limited to any particular method of applying ink to render print imaging. Inkjet cartridges and architectures can include cartridges having separate ink supply portions and printhead portions as well as combined ink supply and printhead portions. Accordingly, the following discussion of a particular embodiment of the present invention including a particular arrangement for delivering ink to render print imaging shall not be taken as limiting the scope of the present invention in its broader aspects.

Cartridges 30 and 32 each carry a printhead, individually referenced as printheads 34 and 36, respectively, projecting ink droplets toward printzone 25. Each printhead 34 and 36, at its bottom surface, presents an orifice plate (not shown) with a plurality of nozzles formed therethrough. Printheads 34 and 36, for example, are thermal inkjet printheads. Other types of printheads 34 and 36 can include piezoelectric printheads.

Printheads 34 and 36, implemented in this particular example as thermal inkjet printheads, each include a plurality of resistors forming a resistive network associated with the printhead nozzles. Energizing a selected resistor quickly heats ink near a nozzle opening and, suddenly, a bubble of gas forms. In this manner, an inkjet nozzle “fires.” The bubble propels or ejects a droplet of ink at the nozzle, i.e. ink positioned between the nozzle opening and heated resistor. The droplet flies toward a sheet of media suitably positioned in printzone 25. Application of print imaging according to a given print job includes coordinating the position of cartridges 30 and 32 within printzone 25, coordinating the position of media within printzone 25, and “firing” the nozzle arrays within printheads 34 and 36 according to print imaging data.

A carriage 38 holds cartridges 30 and 32, along with the corresponding printheads 34 and 36, respectively. Carriage 38 reciprocates or “scans”, i.e., moves laterally back and forth, through printzone 25. Positioning cartridges 30 and 32 during a print job includes controlled reciprocation through printzone 25 and along a scan axis 41 parallel to a lateral axis 52. A laterally-positionable carriage drive system 35 (shown partially) and a guide rod 40 establish movement of carriage 38 back and forth laterally through printzone 25. More particularly, guide rod 40 is a rigid smooth-surfaced structure along which carriage 38 rides. Drive system 35 couples to carriage 38 and moves carriage 38 reciprocally back and forth through printzone 25. In this particular inkjet printer embodiment, drive system 35 includes a laterally disposed toothed belt 37 suspended between a driven gear (not shown) near one end of printzone 25 and an idling gear (not shown) at the opposite end of printzone 25. Thus, coupling carriage 38 to a point on belt 37 propels carriage 38 reciprocally as system 35 alternates directions of rotation for belt 37.

Cartridges 30 and 32 selectively deposit one or more ink droplets on print media located in the printzone 25 in accordance with instructions received via a conductor strip 42 from a printer controller, such as a microprocessor which may be located within enclosure 23 and indicated generally by reference number 44. Controller 44 may receive an instruction signal from a host device, which is often a computer, such as a personal computer, or from a computer network.

System 35 operates cooperatively in response to printer controller 44. The printer controller 44 may also operate in response to user inputs provided through a keypad 46. A monitor coupled to the host computer may be used to display visual information to an operator, such as the printer status or a particular program being run on the computer.

It will be understood, however, that the illustrated embodiment of the present invention need not be limited to a reciprocating or scanning type of printer. The illustrated embodiment of the present invention may include fixed-position ink delivering systems with media moving therepast as well as fixed media with ink delivering systems moving relative thereto. Various mechanisms and methods exist for delivering liquid ink to render print imaging where such ink includes evaporable components.

Ink droplets projected onto media in printzone 25 in liquid form can be dried by, for example, application of energy to better set print imaging rendered thereby.

Printer 20 operation improves, therefore, by placing a drying station 100 following printzone 25. By incorporating a drying station 100 into printing operations conducted by printer 20, print imaging, i.e., liquid droplets deposited on media in printzone 25, more quickly achieves a suitably dry state. For example, printed output desirably reaches a certain level of dryness before release as output from printer 20. Thus, drying station 100 applies energy to printed media just following, e.g., downstream from, printzone 25 and thereby more quickly promotes a suitably dry state thereof, i.e., suitably dry for release as output from printer 20.

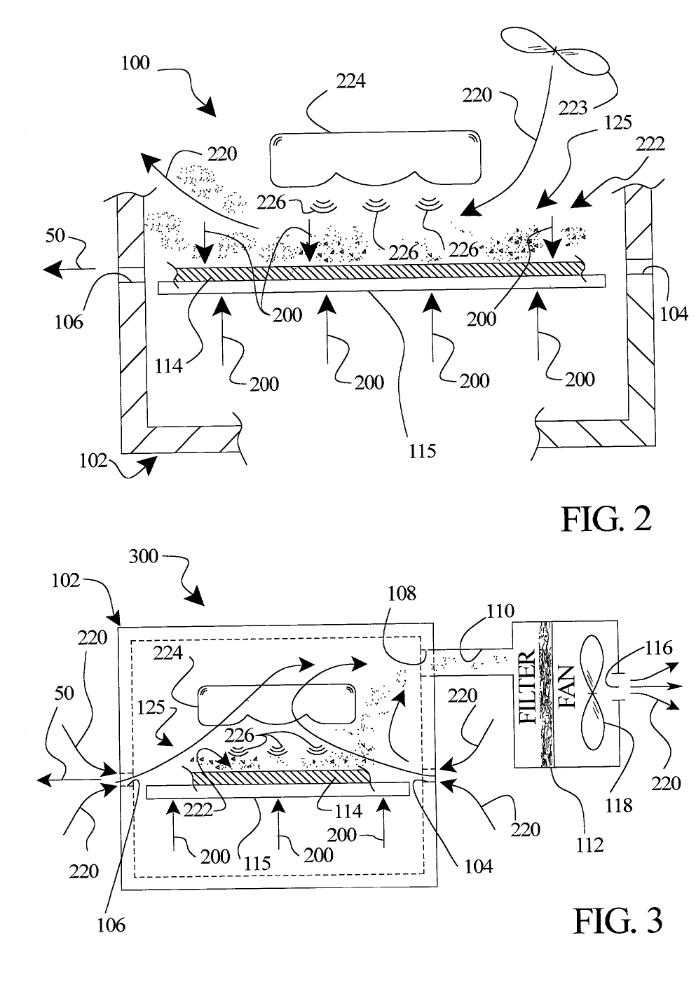

Though illustrated in this particular embodiment as a component of or as attached to printer 20, it will be understood that drying station 100, and various alternate drying stations shown herein, may be provided as a separate drying unit, e.g., a unit separate from printer 20 but substantially as shown and through which media may be fed after application of print imaging thereon. Drying station 100 operates within a shroud 102, receives media input at slot 104 (FIG. 2), and provides media output at slot 106.

FIG. 2 schematically illustrates a form of drying station 100. Shroud 102, shown partially in FIG. 2, may be provided to surround the components of drying station 100 as illustrated in FIG. 2 and include slots 104 and 106 for passing media 114 therethrough and along the feed direction 50. Thus, FIG. 2 illustrates a form of drying station 100 components within shroud 102. Station 100 may be used, however, without a shroud 102. A support surface or platen 115 holds media 114 within shroud 100 and, in this particular illustration, in a desired condition as it passes through shroud 102. Platen 15 may take a variety of forms including but not limited to flat, curved, belt, conveyor, stationary, and moving structures. Platen 115 can be moving and support transport of media 114 through station 100.

Drying station 100 applies energy 200 to media 114. Energy 200 could be ambient energy or surrounding or actively directed toward media 114. Energy 200 may be applied actively by a variety of methods and from a variety of directions and devices, e.g., heated platens, heated rollers, microwave radiation, radio frequency radiation, and the like. Accordingly, energy 200 as represented in FIG. 2 may correspond to many forms of energy surrounding and/or directed at media 114 and resulting, for example, in elevated temperature and/or volatilization of evaporable ink components. Energy 200 includes, but is not limited to, radiant energy, convection energy, heated airflow, kinetic energy, and the like resulting in, for example, elevated temperatures relative to media 114 and/or volatilization of evaporable ink compounds of print imaging previously applied to media 114.

Thus, energy 200 volatilizes components of ink applied to media 114 in printzone 25. As such, drying station 100 defines a volatilization zone 125. Within or near volatilization zone 125, a boundary layer 222 of volatilized ink components develops on the surface of media 114. Airflow to 220 passes through or near volatilization zone 125 and promotes movement of the volatilized ink of boundary layer 222. An air transport, e.g., fan 223, moves airflow 220 relative to volatilization zone 125, e.g., moves airflow 220 through volatilization zone 125. When using shroud 102, fan 223 can be located in or fluidly coupled to shroud 102. Airflow 220 thereby carries away volatilized ink. This “scrubbing” of boundary layer 222 clears away the surface of media 114 for more efficient and more productive further volatilization of evaporable ink components held by media 114.

In accordance with the illustrated embodiment of the present invention, a sound transducer 224 applies sound energy 226, e.g., sound waves 226, to boundary layer 222 and aides in disturbing volatilized ink components thereof. While a sufficient magnitude airflow 220 alone could scrub boundary layer 222, application of sound energy 226 makes movement of volatilized ink in boundary layer 222 more easily accomplished with a lower volume and lower velocity airflow 220. Accordingly, the illustrated embodiment of the present invention supports a lower volume and lower velocity airflow 220 as applied to scrubbing of boundary layer 222. More particularly, the illustrated embodiments support a lower volume and lower velocity airflow relative to other ink drying systems making use of an airflow alone to scrub away a boundary layer.

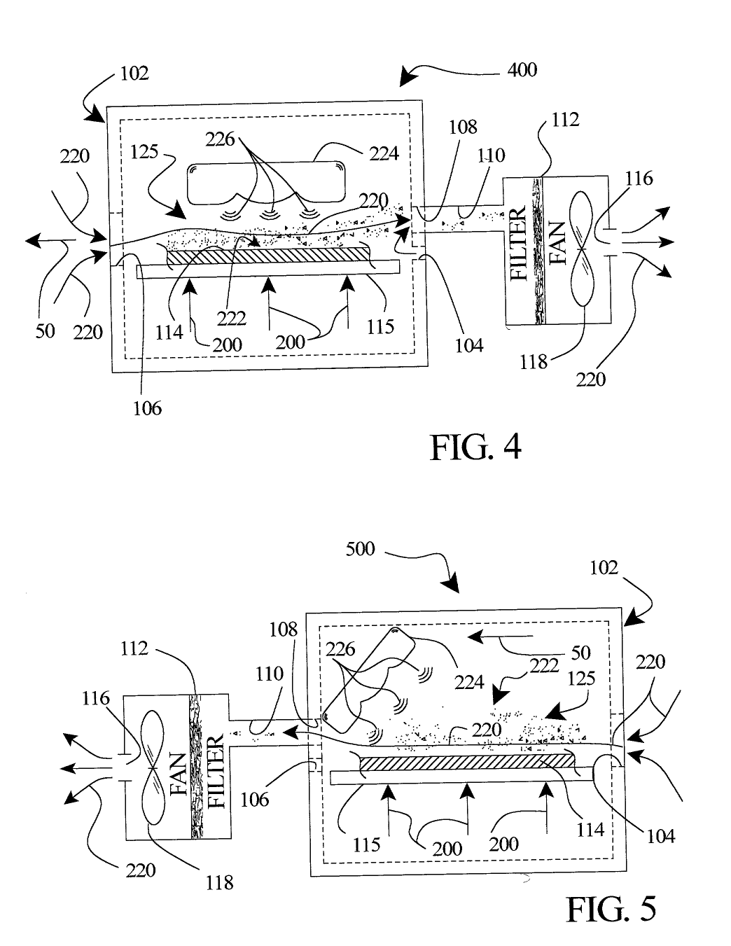

FIG. 3 illustrates another embodiment of an airflow transport as applied to a drying station 300. In FIG. 3, drying station 300 is shown including shroud 102 and slots 104 and 106. Station 300 includes a platen 115 and energy 200 whereby media 114 resting on platen 115 and moving in the feed direction 50 produces a boundary layer 222 in a volatilization zone 125. A sound transducer 224 applies sound energy 226, e.g., sound waves 226, to boundary layer 222.

An air outlet port 108 in shroud 102 couples by way of conduit 110 to a filter 112. On the opposite side of filter 112, a fan 118 draws airflow 220 from within shroud 102, through conduit 110, through filter 112, and out an exhaust port 116. In this particular illustrated embodiment, airflow 220 originates in an ambient or surrounding body of air relative to shroud 102, enters shroud 102 at slots 104 and 106, passes through or by volatilization zone 125 and exits shroud 102 by way of port 108 and conduit 110. In this particular example, airflow 220 assumes a path through shroud 102 supporting collection of ink vapors of boundary layer 222. Application of sound energy, e.g., sound waves 226, in connection with collection of ink vapors by way of airflow 220 contributes to scrubbing of boundary layer 222 and, therefore, more productive drying of media 114.

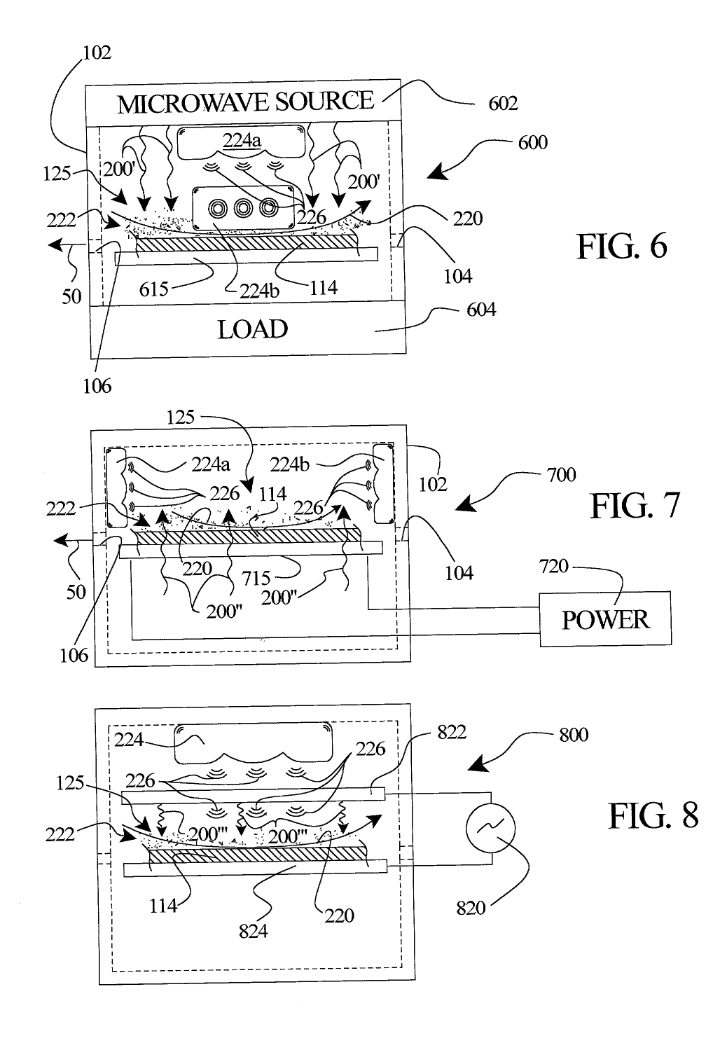

FIG. 4 illustrates an alternative drying station 400 providing a more uniformly directed airflow 220 relative to volatilization zone 125. Thus, station 400 includes a platen 115 and applies energy 200 whereby media 114 resting on platen 115 and moving in feed direction 50 produces boundary layer 222. Sound transducer 224 directs sound energy 226, e.g., sound waves 226, into boundary layer 222 while airflow 220 moves relative thereto. Station 400 includes an outlet port 108 and conduit 110 coupling shroud 102 with a filter 112 and fan 118 whereby airflow 220 taken from shroud 102 passes through filter 112 and out exhaust port 116. Shroud 102 of station 400 is similar to station 300 of FIG. 3, but includes an enlarged media output slot 106 located in such manner to position volatilization zone 125 between slot 106 and port 108. By making slot 106 substantially larger than slot 104, a majority of airflow 220 into shroud 102 comes from slot 106. As a result, airflow 220 assumes a generally uniformly-directly path through volatilization zone 125 and thereby collects volatilized ink from boundary layer 222 for collection at conduit 110. With media 114 moving in feed direction 50 and the majority of airflow 220 moving in an opposite direction, the relative speed between media 114 and airflow 220 improves.

The arrangement illustrated in FIG. 4 may be altered as shown in FIG. 5 to provide a station 500 with a substantially larger input slot 104 relative to output slot 106 and to place the conduit 110 and port 108 on an opposite side of shroud 102 to thereby provide an airflow 220 through volatilization zone 125 but originating generally at the substantially larger slot 104. Airflow 220 passes through volatilization zone 125, out port 108 and into conduit 110 for filtering and exhaust at filter 112, fan 118, and exhaust port 116. Station 500 further includes energy 200 creating the volatilization zone 125 and resulting boundary layer 222. Airflow 220 passes through volatilization zone 125 and scrubs boundary 222 with the assistance of sound energy 226, e.g., sound waves 226, concurrently applied to boundary layer 222.

FIG. 5 also illustrates variation in sound transducer 224 orientation and position, and variation in orientation of approach of sound energy 226, e.g., sound waves 226, toward media 114. While illustrated at a particular angular orientation, it will be understood that sound energy direction as it approaches or passes by media 114 may vary through a range of selectable angles of approach including, but not limited to, parallel through normal angles of approach.

FIG. 6 illustrates a drying station 600 making use of a microwave source 602 directing microwave energy 200′ at media 114 resting on a microwave-transparent platen 615 and into a load 604. Platen 615 may take a variety of forms as described above for platen 115. Source 602 and load 604 may be integrated into shroud 102 generally as indicated in FIG. 6, but as desired according to a particular microwave apparatus waveguide geometry used in a particular embodiment. Media 114 moves through shroud 102 from slot 104 to slot 106 in the feed direction 106 while resting on platen 615. The arrangement illustrated in FIG. 6, generally resembling a slotted microwave applicator or a traveling wave applicator, further includes sound transducers 224a and 224b each as described above and each emanating sound energy 226, e.g., sound waves 226, directed also at or along media 114 as resting on platen 615. As a result, microwave energy 200′ creates a volatilization zone 125 in which the resulting boundary layer 222 receives sound energy 226, e.g., sound waves 226. Volatilized ink compounds produced in response to elevated temperatures of media 114, e.g., such as produced by microwave radiation 200′, are further disturbed by application of sound energy, e.g., waves 226, thereto. While not illustrated in FIG. 6, the embodiment of drying station 600 as shown in FIG. 6 may further include various airflow apparatus for introducing an airflow 220 therethrough in aid of disturbing volatilized ink boundary layer 222. Thus, airflow arrangements including but not limited to those in FIGS. 2-5 may be employed in the drying station 600 of FIG. 6.

FIG. 6 also illustrates concurrent multiple angles of approach for sound energy 226, e.g., sound waves 226. More particularly, station 600 includes two sound transducers 224, individually 224a and 224b. Transducer 224a directs sound waves 226 into media 114 and transducer 224b directs sound waves 226 along the surface of media 114.

FIG. 7 illustrates a drying station 700 making use of a heated platen 715. Platen 715 may take a variety of forms as described above for platen 115. Station 100 includes a shroud 102 with input and output slots 104 and 106, respectively, for passing media 114 through shroud 102. Platen 715 directs energy 200″ into media 114 as it passes in the feed direction 50 thereacross. More particularly, platen 715 couples electrically to a power source 720 and offers electrical resistance to a voltage potential thereof. Platen 715 heats and transfers energy 200″ into media 114 resting thereon. A volatilization zone 125 and boundary layer 222 result. Station 700 further includes transducers 224a and 224b emanating sound energy 226 therefrom. In this particular example, however, sound transducers 224a and 224b face each other and direct sound energy 226, e.g., sound waves 226, laterally inward and along the surface of media 114. As a result, a boundary layer 222 forming at the surface of media 114 receives sound energy 226. Furthermore, station 700 can incorporate airflow devices such as described and illustrated in FIGS. 2-5 for creating an airflow 220 through a volatilization zone 125 within station 700.

FIG. 8 illustrates a station 800 using radio frequency energy 200′″ to create a volatilization zone 125 and boundary layer 222. Station 800 includes a sound transducer 224 producing sound energy 226 directed toward a boundary layer 222 resulting from elevated temperatures of media 114 exposed to radio frequency energy 200′″. More particularly, station 800 includes a radio frequency power source 820 coupled to electrodes 822 and 824. Electrodes 822 and 824 thereby create volatilization zone 125 therebetween and a boundary layer 222. Station 800 includes an airflow 220 moving relative to boundary layer 222 which concurrently also receives sound energy 226, e.g., sound waves 226. As a result, boundary layer 222 is disturbed by sound energy 226 and transported away by airflow 220.

The illustrated embodiments of the present invention may be implemented by use of a variety of heating apparatus and a variety of sound transducers 224. The illustrated and various heating apparatus and sound transducers 224, including variation in number of sound transducers 224 and orientation of sound energy 226 approach, as well as the various methods and apparatus for producing an airflow 220 relative to a boundary layer 222 may be combined in multiple permutations too numerous to detail herein. It will be understood, therefore, that implementations of the present invention may be achieved by combining such variations as illustrated herein according to a particular selected implementation or desired architecture.

A variety of sound frequencies are considered to be useful in assisting ink drying. Sound energy 226 frequencies in the ultrasonic sound range, e.g., above 20 kilohertz (KHz), are considered particularly useful because users in the vicinity of the drying process do not hear the sound waves applied to assist in ink drying. For lower sound energy 226 frequencies, sound dampening or sound insulation measures can be taken to reduce contamination of a surrounding area with audible components of sound energy 226. For example, shroud 102 may include sound insulation. Furthermore, sound energy 226 frequencies considered useful in promoting or assisting ink drying include frequencies below ultrasonic frequencies. Generally, it is believed that sound energy when present assists in ink drying as shown in the various embodiments herein. A variety of sound wave forms have been used with a variety of positive results including pure tone, noise, variation in tone, variation in volume, and a mixture of pure tones and noise sound wave forms. Additionally, the angle of incidence provided with respect to the approach of sound energy 226 toward boundary layer 222 can be varied from orthogonal to parallel relative to media 114 with ink drying assistance resulting through such range. Accordingly, use of sound waves to assist in ink drying may take a variety of configurations across frequencies, sound wave forms, and angle of incidence to assist in or promote more efficiently ink drying.

Application of energy to some forms of media, e.g., plastic-form media, can result in significant damage to such media. In accordance with the illustrated embodiments, however, substantially less energy can be applied when used in conjunction with application of sound energy to disturb a boundary layer and/or in combination with an airflow therethrough. Accordingly, significant drying assistance occurs at substantially lower temperatures. As a result, the illustrated embodiment of the present invention provides opportunity for ink drying assistance with lower temperatures and with less risk of damage to media susceptible to certain temperatures. Furthermore, lower temperatures represent less energy consumed and therefore represent an advantage provided by the illustrated embodiment of the present invention with respect to energy consumption.

A variety of particular sound transducers 224 may be employed. For example, experiments have shown that a speaker-form of sound transducer, e.g., a tweeter, has been used to promote ink drying assistance. However, many other sound transducers may be employed to produce and direct sound energy and thereby aid in ink drying by introducing disruption in a boundary layer by application of sound energy thereto. For example, ultrasonic sound transducers may be used for this purpose.

It will be appreciated that the present invention in its broader aspects is not restricted to the particular embodiment that has been described and illustrated, and that variations may be made therein without departing from the scope of the invention as found in the appended claims and equivalents thereof.

What is claimed is:

1. A drying station comprising:
a zone producing a boundary layer relative to wet media when present therein;
an air source moving air relative to said boundary layer; and
a sound source applying sound energy to said boundary layer.

2. A drying station according to claim 1 wherein said sound source is an ultrasonic sound source.

3. A drying station according to claim 1 wherein said sound energy comprises sound waves.

4. A drying station according to claim 1 wherein said sound energy includes sound energy at a selected frequency.

5. A drying station according to claim 4 wherein said selected frequency is taken from a selected range of frequencies.

6. A drying station according to claim 1 wherein said boundary layer comprises vaporized ink components occupying a space adjacent a surface of media holding evaporable ink components.

7. A drying station according to claim 1 further comprising said wet media bearing print imaging produced by application of liquid ink droplets ejected toward said media, said boundary layer comprising evaporable components of said ink droplets.

8. A drying station according to claim 1 further comprising an energy source taken from the group of energy sources including a microwave energy source, a radiant energy source, a radio frequency energy source, and a convection energy source.

9. A drying station according to claim 1 wherein said drying station is an ink drying station.

10. A drying station according to claim 1 wherein said zone is a volatilization zone

11. In combination,
a printer producing print imaging by application of a liquid colorant on media; and
a drying station accepting said media as bearing said print imaging, said drying station producing a boundary layer by applying energy to said print imaging, said drying station including a sound source directing sound energy at said boundary layer.

12. A combination according to claim 11 wherein said printer is an inkjet printer.

13. A combination according to claim 11 wherein said boundary layer comprises vaporized colorant components occupying a space adjacent a surface of said media.

14. A combination according to claim 11 wherein said printer produces said print imaging by ejecting liquid ink droplets as said colorant toward said media.

15. A combination according to claim 11 wherein said sound source directs ultrasonic frequency sound energy at said media.

16. A combination according to claim 11 further comprising an energy source applying energy to said print imaging to form said boundary layer, said energy source being taken from a group of energy sources including a heat energy source, a microwave energy source, a radiant energy source, a radio frequency energy source, and a convection energy source.

17. A method of drying ink deposited in liquid form on a media substrate, the method comprising:
passing said media through a zone, said zone applying energy to said ink and producing a boundary layer; and
applying sound energy to said boundary layer.

18. A method according to claim 17 wherein said method further comprises the step of providing an airflow relative to said boundary layer.

19. A method according to claim 17 wherein a sound source applies said sound energy at a selected frequency.

20. A method according to claim 17 wherein said energy originates from an energy source taken from the group of energy sources including a microwave energy source, a radiant energy source, a radio frequency energy source and a convection energy source.

21. A drying device comprising:
means for applying energy to media bearing print imaging and thereby producing a boundary layer; and
means for directing sound energy relative to said boundary layer.

22. A drying device according to claim 21 further comprising means for introducing an airflow through a region of air adjacent said media.

23. A drying device according to claim 21 wherein said means for applying energy includes an energy source taken from the group including a microwave energy source, a radiant energy source, a radio frequency energy source and a convection energy source.

24. A method of rendering an image comprising:
applying liquid ink to media, said ink including at least one evaporable component;
forming a boundary layer at a surface of said media including a volatilized state of said evaporable component; and
directing sound energy into said boundary layer.

25. A method according to claim 24 wherein said method further includes introducing an airflow through said boundary layer.

26. A method according to claim 24 wherein said forming a boundary layer includes heating said evaporable component.

27. A method according to claim 26 wherein said heating includes directing energy toward said evaporable component.

28. A method according to claim 27 wherein said directing energy includes directing microwave energy.

29. A method according to claim 27 wherein said directing includes directing radiant energy.

30. A method according to claim 27 wherein said directing includes directing radio frequency energy.

31. A method according to claim 27 wherein said directing includes directing convection energy.

32. A media drying station comprising:
a media transport moving media when present along a feed path;
a media heater applying energy to media moving along said feed path, said heater volatilizing evaporable colorant components of said media as a boundary layer;
an air transport producing an air flow, said air flow being directed at said boundary layer; and
a sound transducer producing sound waves, at least a portion of said sound waves reaching said boundary layer.

33. A media drying station according to claim 32 wherein said sound transducer produces ultrasonic sound waves.

34. A media drying station according to claim 32 wherein said sound waves include sound waves at a selected frequency.

35. A media drying station according to claim 34 wherein said selected frequency is taken from a selected range of frequencies.

36. A media drying station according to claim 32 wherein said boundary layer comprises vaporized ink components occupying a space adjacent a surface of said media holding evaporable ink components.

37. A media drying station according to claim 32 further comprising said media bearing wet print imaging produced by application of liquid colorants to said media, said boundary layer comprising evaporable components of said colorants.

38. A media drying station according to claim 37 wherein said colorants comprise liquid ink.

39. A media drying station according to claim 32 wherein said heater comprising an energy source taken from the group of energy sources including a microwave energy source, a radiant energy source, a radio frequency energy source, and a convection energy source.
